(19) United States
(12) Patent Application Publication
(10) Pub. No.: US 2015/0201662 A1
(43) Pub. Date: Jul. 23, 2015

(54) HEALTH SUPPLEMENT FOOD CONTAINING PEDIOCOCCUS ACIDILACTICI J9, AND METHOD FOR MANUFACTURING SAME

(71) Applicant: J9 BIO AGRICULTURAL ASSOCIATION CORPORATION, Gangwon-do (KR)

(72) Inventor: Jong Gu Lee, Gangwon-do (KR)

(21) Appl. No.: 14/416,971

(22) PCT Filed: Nov. 11, 2013
(86) PCT No.: PCT/KR2013/010180

§ 371 Date: Jan. 23, 2015

(30) Foreign Application Priority Data
Nov. 28, 2012 (KR) 10-2012-0135779

(51) Int. Cl. A23L 1/30; C12R 1/01

(52) U.S. Cl. CPC A23L 1/3014; C12R 1/01; A23V 2002/00

(57) ABSTRACT

Disclosed are a food composition prepared by co-culturing Pediococcus acidilactici with bacillus and a method for preparing the same. The food composition contains bacteriocin, thus improving stability and lifespan of foods. More specifically, disclosed are Doenjang or Cheonggukjang produced by the method, and a method for producing the same.

### CROSS REFERENCE TO RELATED APPLICATIONS

This application is a national stage application of International Application PCT/KR2013/010180, filed Nov. 11, 2013, and claims the benefit of priority to Korean Patent Application No. 10-2012-0135779, filed Nov. 28, 2012, which is incorporated herein by reference in its entirety and for all purposes.

### FIELD OF THE DISCLOSURE

The present invention relates to a health supplement food containing Pediococcus acidilactici J9.

### BACKGROUND

Pediococcus acidilactici produces bacteriocin (U.S. Pat. Nos. 5,260,212 and 5,175,252) and bacteriocin is known as a considerably widely used antibacterial agent. Yogurt containing bacteriocin is registered as U.S. Pat. No. 5,445,835. However, it was not easy to co-culture Pediococcus acidilactici with Bacillus bacteria.

Lactic acid produced by Lactic acid bacteria is known to increase acidity (pH) in the intestine to enhance peristalsis of small intestine and thereby facilitate digestion and absorption, and to control enterokinesia in the large intestine and thereby prevent constipation and diarrhea.

Yogurts and drinks produced by inoculating milk with Lactic acid bacteria, followed by fermentation and solidification are commercially available as fermented milk.

Examples of Lactic acid bacteria used for production of yogurts include Lactic acid bacteria bulgaricus, Streptococcus thermophilus, L. acidophilus and the like. Distinct flavors are imparted to the fermented milk products by respectively culturing these Lactic acid bacteria at low temperatures and suitably mixing two or three thereof. These fermented milk products cannot survive at high temperatures and low pH and, as such, cannot reach human intestines.

Commercially available grain-fermented enzyme-containing products are obtained by fermentation at 30° C. to 35° C. using a single fungus, so-called “A. oryzae”.

As a result of research and experiments at Konkuk University, Korea using Pediococcus acidilactici obtained from the University of Arkansas, US., it was found that bacteriosin which is a natural antibiotic substance produced by Pediococcus acidilactici destroys cell walls of Listeria monocytogenes causing sitotoxism and decreases the number of bacteria to 1.0×10⁵ times after 6 hours.

However, health supplement foods containing bacteriocin produced by Pediococcus acidilactici using grains have not been developed yet.

### SUMMARY

The present disclosure describes that control of pH is easy and food fermentation is thus further facilitated when Pediococcus acidilactici is co-cultured with bacillus and completed the present invention based on the discovery. Conventionally, co-culture of Pediococcus acidilactici with bacillus has been difficult. However, the present disclosure was completed based on the surprising discovery that Pediococcus acidilactici newly isolated by the named inventors was co-cultured well with bacillus.

Therefore, the described embodiments provide a solution to the above problems, and it is one object of the present embodiments to provide a food composition prepared by co-culturing Pediococcus acidilactici with bacillus.

It is another object of the present embodiments to provide a method for producing a health supplement food comprising co-culturing Pediococcus acidilactici with bacillus.

### Technical Solution

In accordance with an aspect of the present disclosure, the above and other objects can be accomplished by the provision of a health supplement food produced by a method including preparing at least one Group A grain selected from the group consisting of brown rice and soybean, and at least one Group B grain selected from the group consisting of black rice, barley and sorghum, soaking a mixture of the Group A and B grains by immersing in water, cooking the soaked grains obtained by immersion using steam, cooling the cooked grains, adding previously cultured Pediococcus acidilactici J9 and the genus bacillus strains to the cooled grains, adding the resulting grains to a solid storage container and solid-culturing microorganisms at a temperature of 40 to 45° C. and at a humidity of 50 to 70% for 20 to 48 hours, further solid-culturing the solid culture product at a temperature of 40 to 45° C. and at a humidity of 20 to 40% for 30 to 60 hours, and drying the resulting solid culture product, followed by grinding.

16S rRNA base sequences of the Pediococcus acidilactici J9 according to the present disclosure were analyzed in order to identify Lactic acid bacteria exhibiting superior heat resistance derived from a traditional Korean soybean paste (Cheonggukjang) by a molecular biological method. Homogeneity of the base sequence of selected strain was compared using the BLAST program of NCBI. As a result, Pediococcus acidilactici was identified at a homogeneity of 99% and this strain was called “Pediococcus acidilactici J9”. The Pediococcus acidilactici according to the present disclosure has antibacterial activity against tae which is a pathogen of bacteremia and tympanitis and is the most predominant pathogen of community-acquired pneumonia. Accordingly, the Pediococcus acidilactici J9 according to the present disclosure was deposited under an accession number of KCCM-11320P at the Korean Culture Center of Microorganisms.

The genus bacillus bacteria may be B. subtilis or B. pumilus. pH of the genus bacillus bacteria is maintained at a level suitable for culture of Pediococcus acidilactici J9 so that efficiency of fermentation was improved. There is no limitation as to the food and the food may be Doenjang or Cheonggukjang.

Upper limits of the culture period, culture temperature and culture humidity are determined in consideration of cost and time required for culture of microorganisms and lower limits thereof are determined to satisfy sufficient conditions for obtaining culture period, culture degree and culture efficiency.

The reason for using brown rice and soybean as major ingredients is to utilize pH control capability between Pediococcus acidilactici J9 (KCCM 11320P) and Bacillus subtilis. Proliferation of Lactic acid bacteria causes formation of lactic acid as an organic acid from glucose, thus decreasing pH concentration and leading to acidification. However, Bacillus subtilis increases pH during fermentation to maintain pH at a neutral level of 6.0, thereby facilitating lactic acid bacteria.

When grains are inoculated with Lactic acid bacteria, Pediococcus acidilactici J9, and fermented at high temperatures, Listeria bacteria inducing sitotoxism was not observed at all. After fermentation, Lactic acid bacteria is proliferated in grains and the number of bacteria cells reaches 1.2×10⁹ CFU/g. Beneficial lactic acid bacteria function to suppress growth of harmful bacteria in the human intestine, strengthen intestinal peristalsis and thereby facilitate bowel movement.

In accordance with another aspect of the presently described embodiments, provided is a method for producing a health supplement food, the method including preparing at least one Group A grain selected from the group consisting of brown rice and soybean, and at least one Group B grain selected from the group consisting of black rice, barley and sorghum, soaking a mixture of the Group A and B grains by immersing in water, cooking the soaked grains obtained by immersion using steam, cooling the cooked grains, adding previously cultured Pediococcus acidilactici J9 and the genus bacillus strains to the cooled grains, adding the resulting grains to a solid storage container and solid-culturing microorganisms at a temperature of 40 to 45° C. and at a humidity of 50 to 70% for 20 to 48 hours, further solid-culturing the solid culture product at a temperature of 40 to 45° C. and at a humidity of 20 to 40% for 30 to 60 hours, and drying the resulting solid culture product, followed by grinding.

The genus bacillus bacteria may be B. subtilis or B. pumilus. pH of the genus bacillus bacteria is maintained at a level suitable for culture of Pediococcus acidilactici J9 so that efficiency of fermentation is improved. There is no limitation as to the food and the food is Doenjang or Cheonggukjang.

In accordance with another aspect of the presently described embodiments, provided is Pediococcus acidilactici J9 (KCCM 11320P) which is co-cultured well with Bacillus bacteria. As can be seen from Example 2 as described later, Pediococcus acidilactici J9 is a strain which is co-cultured well with bacillus and has superior pH stability and resistance to strong acid (see the following Example 3).

### Technical Effects

The food composition according to the presently described embodiments contains Pediococcus acidilactici and inhibits damage of grain fermented product by infection of microorganisms and thereby improves stability and lifespan of products.

In accordance with the method for producing the food composition according to the presently described embodiments, Pediococcus acidilactici J9 is efficiently cultured due to control of pH by bacillus and production of bacteriocin is improved and stability and lifespan of the produced food composition are thus increased.

As can be seen from the above, the food composition containing Pediococcus acidilactici J9 prevents contamination of other microorganisms due to proliferation at high temperatures during fermentation and glycolysis of microorganisms into grains is improved due to surface drying during fermentation. In addition, because of mutual pH buffering action between microorganisms of Pediococcus acidilactici J9 and the genus bacillus, these microorganisms are efficiently proliferated. The food composition containing Pediococcus acidilactici J9 has the same functions as probiotics, for example, functions to facilitate intestinal peristalsis which is an inherent function of Lactic acid bacteria, the functions to suppress harmful bacteria and improve immunity. In addition, in accordance with recent research associated with Pediococcus acidilactici species in the academic world, bacteriocin and lactic acid as natural antibiotics created during fermentation of microorganisms are reported to exhibit antibacterial activity against H. pylori causing peptic ulcer such as stomach ulcer or duodenal ulcer and inhibitory activity to sitotoxism bacteria. The Pediococcus acidilactici according to the present invention exhibits inhibitory activity to S. pneumoniae as pneumonia bacteria. Accordingly, the food composition containing Pediococcus acidilactici J9 is expected to contribute to improvement of national health.

### DETAILED DESCRIPTION

Hereinafter, the presently described embodiments will be described in more detail with reference to examples. The scope to be protected by these embodiments is defined by claims and is not limited to the examples. The presently described embodiments can be implemented by those skilled in the art from the subject matters of the present disclosure and these various embodiments also fall within the right scope of the present inventors defined by claims.

### Example 1

Production of Food Using Pediococcus acidilactici J9 (KCCM 11320P) Stain

A process for producing a grain-fermented enzyme-containing product by inoculating a Pediococcus acidilactici J9 (KCCM 11320P) strain is as follows. Grains used as major ingredients were 60% brown rice and soybean, and black rice, barley and sorghum were added such that the total weight of the grains was 200 kg, in order to improve flavor. The grains were soaked in water for 12 hours. After washing, the grains were cooked under steam in a cooker for about 40 minutes. The cooked grains were cooled. Pediococcus acidilactici J9, B. subtilis and B. pumilus were flask-cultured in an amount of 0.1% with respect to the total weight of grains. The number of the respective microorganisms was adjusted to 1.0×10⁹ CFU/g. The microorganism culture solution was mixed with 2 L of distilled water and the cooked grains were inoculated with the mixture. The inoculated grains were stacked in a plastic box and were then solid-cultured in a fermentation device at a temperature of 42° C. and a humidity of 60% for 24 hours. Then, the inoculated crop was surface-dried at an inner temperature of 42° C. and a humidity of 40% or less for 48 hours to permeate microorganisms into the grains and thereby facilitate glycolysis. After surface drying, the inoculated grains were forcibly dried in a drier to cease fermentation. The dried grains were uniformly ground to 50 mesh in a grinding machine.

### Example 2

### Measurement of the Number of Proliferated Pediococcus acidilactici J9 and the Genus Bacillus Microorganism

The number of Pediococcus acidilactici J9 was measured by counting yellow colonies after culturing at a dilution of 10⁻⁷ with 9 mL of sterile physiological saline per 1 mg of a sample using a Plate count agar with BCP for measurement for 70 hours. The genus Bacillus microorganism was cultured in a nutrient broth agar medium in the same manner as above and white colonies were counted. The number of bacteria is shown in the following Table 1 below.

TABLE 1

| | Pediococcus acidilactici J9 | Genus Bacillus |
|---|---|---|
| CFU/g | 1.2 × 10⁹ | 1.3 × 10⁹ |

As can be seen from Table 1 above, microorganisms were proliferated well to about 10⁹ per 1 g of the sample. In addition, during microorganism proliferation, formation of a natural antibiotic (Bacterocin, Pediosin) and an enzyme as secondary metabolite is well known in the art.

### Example 3

### Test of Antibacterial Activity of Pediococcus acidilactic

The Pediococcus acidilactic was cultured and the concentration of bacteria was then measured using a quick start bovine serum albumin (BSA) standard kit (Bio-Rad, USA). As a result, the concentration of bacteria was 0.465 mg/ml. The culture solution was concentrated at 15,000 rpm for 5 minutes and the supernatant was collected. Then, the residue was filtered with a 0.2 μm filter (Milipore, USA) to remove bacteria and thereby prepare a Pediococcus acidilactic extract.

Six standard strains shown in the following Table 2 were cultured using a standard flat comparison method in a CO₂ constant-temperature incubator at 37° C. for 24 hours.

TABLE 2

| | | ATCC | | |
|---|---|---|---|---|
| | Name | number | Note | Grade |
| 1 | Pseudomonas | 27853 | MAC | 1 |
| | aeruginosa | | | |
| 2 | Staphylococcus | 29213 | BAP | 2 |
| | aureus | | | |
| 3 | Streptococcus | 49619 | BAP | 2 |
| | pneumoniae | | | |

A single colony-forming unit of each standard strain was seeded on a blood agar plate and a P. acidilactici extract was inoculated at 5 μl, 10 μl, 20 μl and 100 μl. The strains were dried in the air in a clean bench for 10 minutes and cultured in a CO₂ constant-temperature incubator at 37° C. for 24 hours. Then, diameter of the inhibition zone was measured by measuring the size of spots and results are shown in Table 3.

TABLE 3

| | Name | ATCC number | Results |
|---|---|---|---|
| 1 | Pseudomonas aeruginosa | 27853 | No effect |
| 2 | Staphylococcus aureus | 29213 | No effect |
| 3 | Streptococcus pneumoniae | 49619 | effect |

As can be seen from Table 3 above, P. acidilactici extract inhibited growth of Streptococcus pneumoniae ATCC49619. An inhibition diameter (mm) at different extract concentrations was not calculated for 5 μl, and inhibition diameters (mm) were 3 mm, 6 mm and 13 mm for different extract concentrations of 10 μl, 20 μl and 100 μl, respectively. Characteristic α-hemolysis of Streptococcus pneumoniae was not observed in a region where the P. acidilactici extract was inoculated and bacteria were not cultured, which means that growth of S. pneumoniae bacteria was inhibited.

### Example 4

### Test of pH Stability of Pediococcus acidilactici J9

First, a 0.5% Lactobacilli MRS medium (Difco Laboratories Inc.) was diluted in 200 mL of distilled water and was sterilized and pH of the dilution was then adjusted to 3.0 with an HCl solution.

Pediococcus acidilactici J9 was diluted at a density of 3.0×10⁸ CFU/g with physiological saline and was maintained for a lead time of 30 minutes. An aqueous solution (pH 3.0) was inoculated at 10% with the Pediococcus acidilactici J9 solution and at 37° C. and the number of lactic acid bacteria was measured after culturing for one hour and two hours. The number of Pediococcus acidilactici J9 was measured by counting yellow colonies after culturing at a dilution of 10⁻⁷ with 9 mL of sterile physiological saline per 1 mg of a sample using a Plate count agar with BCP for measurement for 70 hours.

As a result, it was confirmed that the number of bacteria was not varied at all. This means that Pediococcus acidilactici J9 had superior pH stability and resistance to strong acid. Accordingly, there was a high probability that Pediococcus acidilactici J9 could reach the human intestine alive when passed through the human stomach and intestine.

TABLE 4

| Acidity resistance test | Pediococcus acidilactici J9 |
|---|---|
| Number of bacteria after one hour | 1.9 × 10⁸ |
| (CFU/g) | |
| Number of bacteria after two hours | 1.2 × 10⁸ |
| (CFU/g) | |

### Example 5

### Test for Confirming Thermal Stability of Pediococcus acidilactici J9

First, Pediococcus acidilactici J9 was cultured in a Lactobacilli MRS medium (Difco Laboratories Inc.) and immersed in 200 mL of distilled water in a constant temperature bath at 90° C. for 2 minutes.

The number of Pediococcus acidilactici J9 was measured by counting yellow colonies after culturing at a dilution of 10⁻⁷ with 9 mL of sterile physiological saline per 1 mg of a sample using a Plate count agar with BCP for measurement for 70 hours.

As a result, regarding the number of bacteria, Pediococcus acidilactici J9, as a control group before test was 2.9×10¹⁹ and the number of bacteria was 2.0×10⁹ at 90° C. for 2 minutes, which means Pediococcus acidilactici J9 has superior thermal stability.

TABLE 5

| Thermal stability test | Pediococcus acidilactici J9 |
|---|---|
| Number of bacteria before test (CFU/g) | 2.9 × 10¹⁰ |
| Number of bacteria at 90° C., after 2 | 2.0 × 10⁹ |
| minutes (CFU/g) | |

Although the preferred embodiments have been disclosed for illustrative purposes, those skilled in the art will appreciate that various modifications, additions and substitutions are possible, without departing from the scope and spirit of the disclosure as disclosed in the accompanying claims.

1. A health supplement food produced by a method comprising:
preparing at least one Group A grain selected from the group consisting of brown rice and soybean, and at least one Group B grain selected from the group consisting of black rice, barley and sorghum;
soaking a mixture of the Group A and B grains by immersing in water;
cooking the soaked grains obtained by immersion using steam;
cooling the cooked grains;
adding previously cultured Pediococcus acidilactici J9 and the genus bacillus strains to the cooled grains;
adding the resulting grains in a solid storage container and solid-culturing microorganisms at a temperature of 40 to 45° C. and at a humidity of 50 to 70% for 20 to 48 hours;
further solid-culturing the solid culture product at a temperature of 40 to 45° C. and at a humidity of 20 to 40% for 30 to 60 hours; and
drying the resulting solid culture product, followed by grinding.

2. The health supplement food according to claim 1, wherein the genus bacillus bacteria is B. subtilis or B. pumilus.

3. The health supplement food according to claim 1, wherein the food is Doenjang.

4. The health supplement food according to claim 1, wherein the food is Cheonggukjang.

5. A method for producing a health supplement food, the method comprising:
preparing at least one Group A grain selected from the group consisting of brown rice and soybean, and at least one Group B grain selected from the group consisting of black rice, barley and sorghum;
soaking a mixture of the Group A and B grains by immersing in water;
cooking the soaked grains obtained by immersion using steam;
cooling the cooked grains;
adding previously cultured Pediococcus acidilactici J9 and the genus bacillus strains to the cooled grains;
adding the resulting grains in a solid storage container and solid-culturing microorganisms at a temperature of 40 to 45° C. and at a humidity of 50 to 70% for 20 to 48 hours;
further solid-culturing the solid culture product at a temperature of 40 to 45° C. and at a humidity of 20 to 40% for 30 to 60 hours; and
drying the resulting solid culture product, followed by grinding.

6. The method according to claim 5, wherein the genus bacillus bacteria is B. subtilis or B. pumilus.

7. The method according to claim 5, wherein the food is Doenjang.

8. The method according to claim 5, wherein the food is Cheonggukjang.

9. Pediococcus acidilactici J9 (KCCM 11320P) having antibacterial activity against Streptococcus pneumoniae, being rapidly grown upon co-culture with the genus bacillus strains and improving stability of foods when added to the foods.
